(19) United States
(12) Patent Application Publication
(10) Pub. No.: US 2008/0195400 A1
(43) Pub. Date: Aug. 14, 2008

(54) Ticketing Scheme

(75) Inventors: Barry Sim Hochfield, Glasgow (GB); Michael Peters, Lenzie (GB); Stuart Williamson, East Kilbride (GB)

Correspondence Address: FOLEY AND LARDNER LLP;SUITE 500, 3000 K STREET NW, WASHINGTON, DC, 20007, US

(73) Assignee: eCEBS LIMITED, Sheffield (GB)

(21) Appl. No.: 11/579,804

(22) PCT Filed: May 16, 2005
(86) PCT No.: PCT/GB2005/001899

§ 371 Date: Mar. 28, 2008

(30) Foreign Application Priority Data
May 14, 2004 (GB) 0410861.9
Dec. 23, 2004 (GB) 0428320.6

(51) Int. Cl. G06Q 99/00

(52) U.S. Cl. 705/1

(57) ABSTRACT

In an ITSO scheme, construction and initial sealing of ITSO Product Entities (IPEs) is carried out by one of a plurality of ITSO Secure Application Modules (‘ISAMs’) at a location remote from ticket retailer devices at which the IPE fields are generated. Each ticket retailer device is connected to an ISAM over the Internet or other network by control means operable to select an available ISAM from an ISAM array for the duration of a sealing transaction initiated by that ticket retailer device. Validation of IPEs can also be carried out at a remote ISAM array accessed over the Internet or other network. The remote ISAM array can be used in a variety of ITSO applications, for example, transportation ticket sales or secure systems for the prescription of drugs. In the latter scheme, prescription information is presented by the prescription writer for sealing in the form of an IPE and the patient can later validate the prescription IPE at a pharmacy or other supplier. Such a scheme can be used to reduce prescription fraud significantly because of the security inherent in the ITSO scheme.

The present invention relates to an improved ticketing scheme utilising the basic structure of the ITSO scheme. For the purposes of this document, the term ‘ITSO’ is intended to denote the Interoperable Ticketing Smartcard Organisation standards developed by UK Government and incorporated in European Standard EN 1545, in any of the versions currently available or which become available in future. As will be seen from the description below, the term ‘ticketing scheme’ does not only encompass traditional transportation ticketing operations but any secure scheme in which a ticket, token, voucher, or prescription is validated for redemption against the provision of goods or services.

The existing ITSO scheme's security architecture depends on the inclusion of an ITSO Secure Application Module (‘ISAM’) at every point-of-service terminal (‘POST’) for every ticketing use, be it ticket sales or ticket validation. It is clear that for ticket franking the scheme policing functions performed by the ISAM must be completed in a very short period of time, so as not to impede service, when boarding a bus or passing through a turnstile.

Consequently, in existing schemes, the ISAM must be physically installed in the POST so that the transaction can take place ‘off-line’ of any central host computer which would otherwise be too slow and expensive to communicate with, especially for moving vehicles such as buses.

However, we have appreciated that, in the particular case of ticket purchasing, this ‘high speed therefore off-line’ argument is not valid; ticket selection and purchasing events can take many seconds, or even minutes, to complete. Additionally, there are adverse cost implications in upgrading all existing ticket retailing POSTs by installing an ISAM, and so an alternative approach is required to provide ITSO ticket retailing more economically.

In broad terms, in accordance with the invention, there is provided an ITSO scheme in which sealing or validation of ITSO Product Entities (IPEs) is carried out by one of a plurality of ITSO Secure Application Modules (‘ISAMs’) at a location remote from ticket retailer devices from which the IPE fields are derived; each ticket retailer device is connected to an ISAM or plurality of ISAMs over the Internet or other network by control means operable to select an available ISAM from the plurality of ISAMs for the duration of a sealing or validation transaction initiated by that ticket retailer device.

The “sealing” of an IPE is in a sense providing an authentication code known as a MAC (message authentication code). This can be by using any of a number of known algorithms such as the DES algorithm. In essence, the IPE has a signature created and stored with the IPE so that the IPE can later be validated by checking the signature or authentication code.

The validation of an IPE is the process of checking the previously generated authentication code produced when sealing the IPE. Validation is also known as authenticating and is conducted at the ISAM remote from the retailer devices. In the embodiment of the invention described, the process of sealing an IPE is conducted at an ISAM remote from the retailer device. In addition, the process of authenticating or validating the IPE is also conducted at the ISAM remote from the retailer devices.

Such a scheme is particularly suited to the sale of transportation tickets, as mentioned above but is also suited to other schemes where the time taken to seal or validate a token, voucher or other ‘ticket’ is not critical. In particular, the scheme described may be used to validate prescriptions for pharmaceutical preparations and medicines. The invention further provides a scheme for issuing prescriptions for drugs wherein prescription information is transmitted by a doctor or other prescription writer in the form of an ITSO Product Entity (‘IPE’) sealed in accordance with the scheme of the invention outlined above. Similarly, in accordance with the invention, prescriptions for drugs are validated by presenting prescription information at a validation device in the form of an ITSO Product Entity (‘IPE’) and validating that information at one of a plurality of ITSO Secure Application Modules (‘ISAMs’) at a location remote from the validation device (such as a POST) at which the IPE is presented for validation; each validation device being connected to an ISAM over the Internet or other network by control means operable to select an available ISAM from the array for the duration of a validation transaction initiated by that validation device.

The invention also provides an ISAM array for use in a scheme of the kind outlined above, the array comprising a plurality of ISAMs and control means responsive to a retailer or validation request transmitted over the Internet or other network to the control means from a retailer or validation device at a remote location; the control means being operable to select an available ISAM from the plurality of ISAMs and to connect it to the retailer or validation device over the Internet or other network for the duration of a sealing or validation transaction initiated by that retailer or validation device.

The “array” of ISAMs is a logical grouping of a plurality of ISAMs. This allows multiple requests for either sealing or authentication of IPEs to be submitted at any time and processed in parallel. The control means is able to determine the appropriate ISAM for any given sealing or authentication request. Additionally, the ISAMs can be arranged in logical groups within the array so that a particular grouping of ISAMs is provided, for example, for any one source of sealing or validation requests. In an embodiment of the invention, the source may be a particular retailer or operator such that requests for that given retailer or operator are provided to a corresponding one of the groups of ISAMs within the array. A POST system distributed over the Internet, in accordance with the invention, will now be described by way of example, with reference to the drawings, in which:

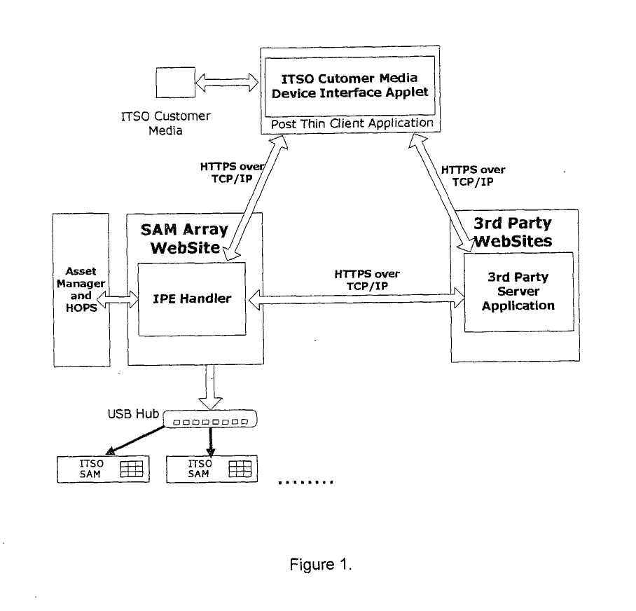

FIG. 1 is a block diagram providing an overview of the system architecture;

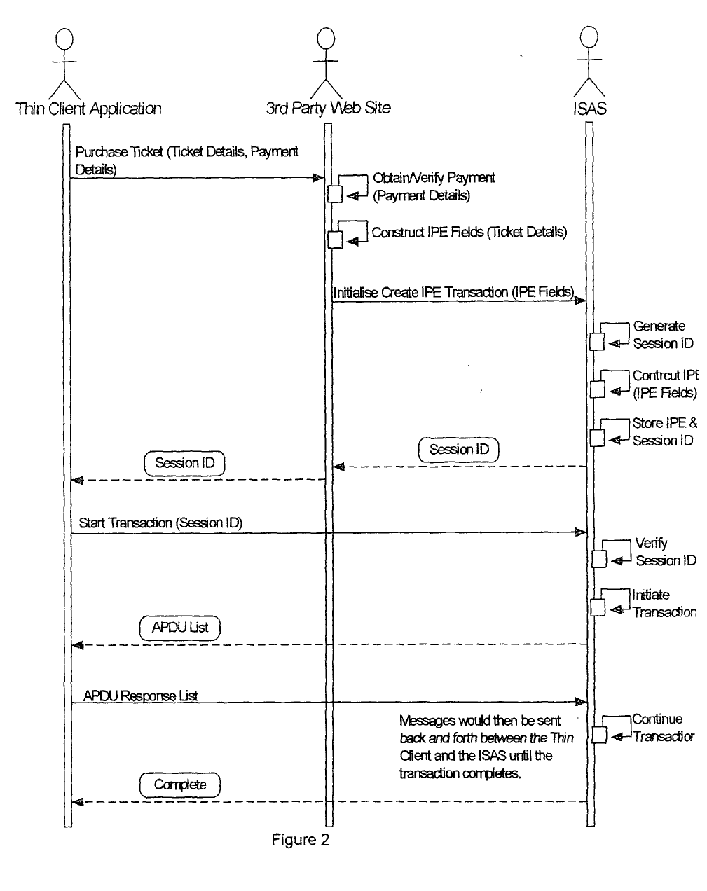

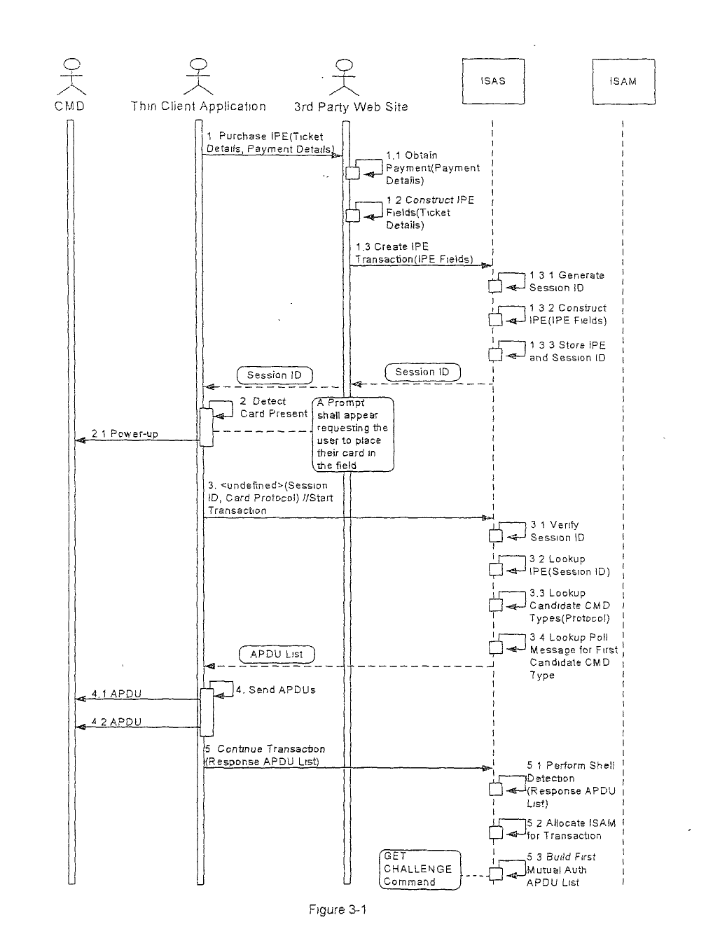

FIG. 2 shows diagrammatically an overview of the flow of events; and

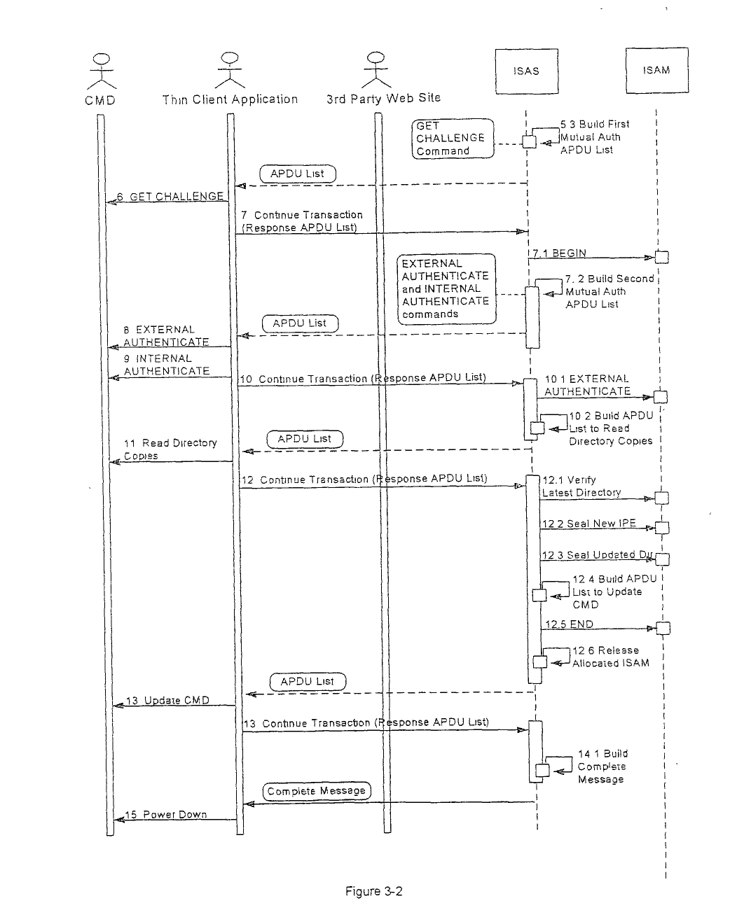

FIG. 3 shows the flow of events in greater detail.

The ITSO scheme operates using ITSO product entities (IPEs) which comprise data relating to a transaction and which are sealed, validated or authenticated using an algorithm as described above. The ITSO product entities themselves (IPES) comprise a plurality of IPE fields which together comprise an IPE. The process of assembling the IPE fields into an IPE is known as construction. In the embodiment described, the construction of the IPE may be at the retailer device (POST) and at which the request for validation is made, or the retailer device may simply provide the IPE fields to a remote third party site at which the IPEs are constructed from the IPE fields. Whichever route is chosen, the IPEs are sealed at an ISAM remote from the retailer device. In addition, any request for authentication or validation of an IPE that has already been sealed is also made to the remote ISAM device. The fields of an IPE are also known as components.

As can be seen from FIG. 1, the system embodying the invention comprises two web servers. One of these (‘SAM Array WebSite’ or ISAS) has an ‘array’ of ISAMs attached, connected via the Internet to the other which carries third party websites (‘3rd Party WebSites’) run by ticket retailers, which provide ticket selection functions to clients, who are the ticket purchasers.

The ISAM array may have any number of ISAMs; in this case there are assumed to be X such ISAMs in the array. Similarly there may be any number of third party websites on the other server (there may in fact be any number of third party servers, each hosting any number of third party websites); in this case there are assumed to be Y such websites. Each ticket retailing website may, in turn, be accessible from a large number, Z, of devices from which it may be accessed by those wishing to purchase tickets.

The ISAM array and its management layers act like a telephone switch, routing X ISAMs to Y third party websites which, in turn, route to Z terminals (‘Customer Media Interface Devices’) on a session-by-session basis. There are, thus X*Y*Z possible connections and this allows one array of ISAMs to be shared across more than one third party web ticket reselling website and by many more terminals.

The combination of logical and physical components in the form of the hub and IPE handler shown in the diagram of FIG. 1 provides a control means by which requests for either validation or sealing of IPEs can be allocated to the appropriate SAM or group of SAMS within the SAM array.

The flow of events under an ITSO scheme implemented as outlined above in relation to FIG. 1 is illustrated in greater detail in FIGS. 2 and 3. As can be seen from FIG. 2, a customer logs onto a 3^{rd} party website in the usual way and the ticket purchase transaction is handled between the customer and the 3^{rd} party website in the usual way until payment has been effected and ticket details established. At this point the 3^{rd} party website contacts the ITSO Sam Array Website (‘ISAS’) to establish a session. The ISAS establishes a session and transmits a session identification back to the 3^{rd} party website and on to the customer. Using the ticket details already established by the 3^{rd} party website, the ISAS (‘Customer Media Interface’) initiates a dialogue with the customer until the ticket sealing transaction is complete.

In this embodiment, the IPE fields are generated at a third party website and are transmitted to the ISAS where the IPE is constructed. It is the ISAS which then transmits the IPE to the ISAM for sealing. As previously explained, it is also possible that the IPE could be constructed entirely at the retailer device or third party website. An additional feature of the embodiment (inherited from the ITSO scheme) is that the fields from which the IPEs are constructed are put together in an efficient manner so that any padding between fields is removed to ensure the construction of the IPE is small in size for subsequent storage in the users smart card (customer media device).

As explained, the generation of an IPE may be either at a POST in which the entire IPE is constructed, or the fields of the IPE may be created at the POST and transmitted to a third party site for construction, or the fields of the IPE may be created at the third party site and transmitted to an ISAS for construction. In either of these alternatives, the IPEs are derived from the POST or retailer devices in the sense that data input at the POST causes the IPE to be constructed either at the POST itself, at the third party site, or at the ISAS.

FIG. 3 shows this process in greater detail, in particular, the communication between the ISAS and the individual ISAM used in a particular transaction session.

The details of the ITSO transactions carried out by the ISAM may be entirely conventional within the ITSO scheme.

The advantages of the approach described above are:
there is no need to install one ISAM per POST
third party websites are dynamically associated with the ISAM Array
dynamic association of an Internet client with a ticket retailing website.

Providing the client terminal (‘Customer Media Interface’ or ‘CMI’) used to access the 3^{rd} party website, and thus the ISAS, has a smartcard reader device attached, ITSO Product Entities (‘IPEs’), the ITSO formatted and secured ‘ticket’, can be loaded onto the CMD (‘Customer Media Device’) remotely, using the best level of security the particular type of CMD can support. Also, if the CMD is dual interface (ISO 7816-3 and ISO 14443) the reader device does NOT need to be an ISO 14443 reader which is advantageous, as these are more costly.

While approaches based on arrays of smartcards being accessed over a network have been implemented before, these have only been for applications such as the Mondex purse, which are limited to ‘value transfer’ protocols between smartcards acting as logical peers. The scheme of the invention described above provides a dynamically configurable, secure end-to-end protocol over the Internet between the ISAM and many different types of CMD, based on the level and kind of security the CMD can support. The security protocols may include the following:
Card ID derived access passwords per memory sector. While these are transferred ‘in the clear’ they were derived at CMD issuance and can only be used on one particular CMD.
Mutual authentication based on shared secret keys (Card ID derived). This gives a higher level of assurance that the CMD is genuine, also, the CMD may only be updated following a successful mutual authentication.
Secure messaging, based on shared secret keys (Session and Card ID derived). This ensures that the data read and written to/from the CMD cannot be altered ‘in transit’ or replayed at a later time, as it is ‘sealed’ with a one time session based cryptogram. This is over and above the security protecting the IPE contents itself.

The system above, as mentioned, lends itself to a variety of situations other than issuing of transport tickets, the application for which the ITSO scheme was originally developed. One of particular interest is that of prescription fraud.

Prescription fraud is perpetrated in many ways. The paper-based systems used worldwide today are prone to misuse by fraudsters taking the roles of medical professionals, patients, and the pharmacies and others. Use of smart cards has been envisaged for some time as a platform to help combat these frauds and the ongoing development of smartcard ID schemes for patients is conventionally thought to be progress in the right direction. However the specifics of precisely how a fully flexible scheme allowing for multiple commercial entities, be they pharmacies, medical practices or, importantly, public sector bodies such as governments involved in subsidies or concessionary type reimbursements of prescription charges, have not been forthcoming, mostly because of the huge complexities in managing the commercial and security dynamics of such schemes.

The ITSO Security Architecture can with very few modifications be used as the basis of an Open Scheme (“Open” meaning available to multiple users, some of whom are competitors, e.g. Visa is an Open Scheme) for the secure dispensing, fulfillment, payment and reimbursement of pharmaceutical prescriptions.

Referring to the standard ITSO specifications this document a number of modifications and enhancements are required to apply an ITSO scheme to the area of preventing prescription fraud, as follows.

Firstly, the card held by the patient will need to also be a Secure ID card. It will have to have been issued to the patient using enrolment procedures secure enough to give the overall scheme operator confidence that the patient's identity can be authenticated satisfactorily and that duplicate enrolments have not occurred. There are various known cryptographic and security protocol techniques which can be employed, and these in themselves are not the subject of this application.

Other “role-holders” in the scheme must also have their identities authenticated via the use of a smartcard, for example, the doctor or other prescription writing authority (such as a senior nurse authorised to renew repeat prescriptions for chronic conditions) writing a prescription and the pharmacist filling the prescription and receiving payment, be it full, partial, direct or subsidized.

The patient's card has within it a secure data structure referred to in the ITSO specifications as an ITSO Shell. This is, in effect, an electronic wallet for tickets of many different types. These ticket types have templates for the data items with pre-set definitions within each ticket or IPE (‘ITSO Product Entity’). There is also an IPE type known as Private, in which none of the data items are defined, only the ITSO security is employed to ‘seal’ the ticket data, thus guaranteeing its integrity.

The system described above utilising an array of remote ISAMs and shown in the drawings provides a practicable scheme by means of which a secure prescription issuing and filling may be carried out. Firstly, it avoids the need for an ISAM to be installed in every POST, in this case, in doctors' surgeries and in pharmacies. Further, it provides a means by which electronic tickets representing prescription information can be securely downloaded remotely over networks such as the Internet or Intranet (private network) versions thereof. This system keeps the ticket, or in this case prescription issuing process, secure by locating the security-providing elements (the ISAM) within a controlled location(s). However ISAMs could also be located within other locations such as doctors' surgeries and pharmacies.

Using this process, a ticket can be selected, paid for and delivered to a service user's card on line over the Internet. The architecture is based on two web sites, the first principally being responsible for the selection and payment, the second being responsible for the secure delivery. If the ticket in question now is in fact a prescription, the on-line process can be modified as follows.

The two stages of sealing IPEs and validating IPEs in the context of a prescription issuing system can now be understood. In a first embodiment, a doctor causes an IPE to be constructed either by construction at a POST within the doctor's surgery or by transmitting IPE fields to a third party site where the IPE is constructed. The IPE contains the prescription data and this is sealed at the SAM. The patient's card is also present at the POST in this process so that the sealing of the IPE is related to the patient's smart card. Subsequently, the patients can present their smart card and the sealed IPE can be validated based on the patient's smart card at a different POST at the pharmacy.

The doctor authenticates to the prescription management web site and ‘writes’ the prescription for the patient. The doctor's card is involved in this process. The patient's card can be present at the same time or can log in later to ‘pick up’ the prescription. Then the patient authenticates themselves to the prescription management web site, which then instigates the prescription download using the same processes described above.

When the patient presents his/her card at the pharmacy, the pharmacist's terminal may have an ISAM, or may also be on line over an Intranet to an ISAM array server, which validates the prescription and modifies/franks it accordingly (depending on whether the prescription is a one-time or repeat). The ISAM then participates in the creation of a secure transaction record, which is uploaded at a later time to instigate payment and reimbursement procedures according to whatever commercial arrangements and policies apply for the particular individuals involved.

It should be noted that prescription issuing can also occur “off-line” at a doctor's terminal, provided the terminal is fitted with three card readers (one for the doctor, one for the patient and one for the ISAM). This ISAM is also interrogated on occasion for its prescription issuing transaction records which provide a fully accounted scheme as compared against the pharmacist's transaction records. This ‘closed loop’ scheme will provide the same kinds of benefits as in the transport ticket area in terms of reducing discrepancies and many types of fraud.

1. An ITSO scheme in which sealing of ITSO Product Entities (IPEs) is carried out by one of a plurality of ITSO Secure Application Modules (‘ISAMs’) at a location remote from ticket retailer devices from which the IPEs are derived; each ticket retailer device being connected to an ISAM over the Internet or other network by control means operable to select an available ISAM from the plurality of ISAMs for the duration of a sealing transaction initiated by that ticket retailer device.

2. A method of sealing an IPE in an ITSO scheme comprising:
generating the fields of an ITSO Product Entity (‘IPE’) at a ticket retailer device; and constructing and sealing the IPE by means of one of a plurality of ITSO Secure Application Modules (‘ISAMs’) at a location remote from the retailer device from which the IPEs are derived; each ticket retailer device being connected to an ISAM over the Internet or other network by control means operable to select an available ISAM from the plurality of ISAMs for the duration of a sealing transaction initiated by that ticket retailer device.

3. An ITSO scheme in which validation of an IPE is carried out by one of a plurality of ISAMs at a location remote from validation devices from which IPEs are derived for validation; each validation device being connected to an ISAM over the Internet or other network by control means operable to select an available ISAM from the plurality of ISAMs for the duration of a validation transaction initiated by that validation device.

4. A method of validating an IPE in an ITSO scheme comprising:
deriving an ITSO Product Entity (‘IPE’) from a validation device; and
validating the IPE by means of one of a plurality of ITSO Secure Application Modules (‘ISAMs’) at a location remote from the validation device from which the IPE is derived; each validation device being connected to an ISAM over the Internet or other network by control means operable to select an available ISAM from the plurality of ISAMs for the duration of a validation transaction initiated by that validation device.

5. A scheme for issuing prescriptions for drugs wherein prescription information is transmitted by a doctor or other prescription writer to create an ITSO Product Entity (‘IPE’) sealed by one of a plurality of ITSO Secure Application Modules (‘ISAMs’) at a location remote from retailer devices at which the IPEs are generated; each retailer device being connected to an ISAM over the Internet or other network by control means operable to select an available ISAM from the array for the duration of a sealing transaction initiated by that retailer device.

6. A scheme for validating prescriptions for drugs wherein prescription information is presented at a validation device to create an ITSO Product Entity (‘IPE’) and is validated by one of a plurality of ITSO Secure Application Modules (‘ISAMs’) at a location remote from the validation device at which the IPE is presented for validation; each validation device being connected to an ISAM over the Internet or other network by control means operable to select an available ISAM from the array for the duration of a validation transaction initiated by that validation device.

7. A method of issuing prescriptions for drugs comprising:
generating an ITSO Product Entity (‘IPE’) representing prescription information from a retailer device; and sealing the IPE by means of one of a plurality of ITSO Secure Application Modules (‘ISAMs’) at a location remote from the retailer device at which the IPE is generated; each retailer device being connected to an ISAM over the Internet or other network by control means operable to select an available ISAM from the plurality of ISAMs for the duration of a sealing transaction initiated by that retailer device.

8. A method for validating prescriptions for drugs wherein:
prescription information is presented for validation in the form of an ITSO Product Entity (‘IPE’) derived from a validation device; and
validating the IPE by one of a plurality of ITSO Secure Application Modules (‘ISAMs’) at a location remote from the validation device at which the IPE is presented for validation; each validation device being connected to an ISAM over the Internet or other network by control means operable to select an available ISAM from the plurality of ISAMs for the duration of a validation transaction initiated by that validation device.

9. An ISAM array for use in a scheme according to claim 1, the array comprising a plurality of ISAMs and control means responsive to a retailer or validation request transmitted over the Internet or other network to the control means from a retailer or validation device at a remote location; the control means being operable to select an available ISAM from the plurality of ISAMs and to connect it to the retailer or validation device over the Internet or other network for the duration of a sealing or validation transaction initiated by that retailer or validation device.

10. An ISAM array according to claim 7 wherein the control means is operable to connect a plurality of retailer or validation devices to respective ones of the plurality of ISAMs simultaneously.

11. A method or scheme according to claim 1 or an ISAM array comprising a plurality of ISAMs and control means responsive to a retailer or validation request transmitted over the Internet or other network to the control means from a retailer or validation device at a remote location; the control means being operable to select an available ISAM from the plurality of ISAMs and to connect it to the retailer or validation device over the Internet or other network for the duration of a sealing or validation transaction initiated by that retailer or validation device in which the plurality of ISAMs are grouped in separate respective logical groups.

12. A method, scheme or ISAM array according to claim 11, wherein requests for sealing or validation are received at the ISAM array from a plurality of third parties, each third party being allocated to a respective group of ISAMs.

13. A system for sealing or validation of ITSO product entities (IPEs) comprising interfaces for receiving requests for sealing or validation, an IPE handler for handling requests for sealing or validation and a plurality of ITSO secure access modules (ISAMs) arranged to receive the sealing or validation requests, wherein the interface and IPE handler are arranged to present the sealing or validation requests to one or a group of ISAMs based upon control logic.

14. A system according to claim 13 in which the control logic is arranged to select an appropriate ISAM or group of ISAMs based on the source of the request.

15. A method, scheme or system according to claim 1 in which the ISAMs comprise smartcards.

16. A method, scheme or system according to claim 1 in which the ISAMs are implemented as logical functions on a server or servers.
